(19) United States
(12) Patent Application Publication
(10) Pub. No.: US 2023/0364818 A1
(43) Pub. Date: Nov. 16, 2023

(54) RAZOR BLADE HAVING AN ASYMMETRICAL EDGE

(71) Applicant: DORCO CO., LTD., Gyeonggi-do (KR)

(72) Inventors: Min Joo PARK, Seoul (KR); Hyun Kyu JUNG, Gyeonggi-do (KR); Seong Won JEONG, Gyeonggi-do (KR); Myoung Jin KIM, Gyeonggi-do (KR)

(73) Assignee: DORCO CO., LTD., Gyeonggi-do (KR)

(21) Appl. No.: 18/247,873

(22) PCT Filed: Sep. 3, 2021
(86) PCT No.: PCT/KR2021/011934

§ 371 Date: Apr. 4, 2023

(30) Foreign Application Priority Data
Oct. 27, 2020 (KR) 10-2020-0140236
Jul. 16, 2021 (KR) 10-2021-0093298

(51) Int. Cl. B26B 21/56

(52) U.S. Cl. CPC B26B 21/56; B26B 21/60

(57) ABSTRACT

A razor blade is provided. The razor blade includes a substrate including a substrate tip, and a first surface and a second surface extending from the substrate tip; and a coating, layered on the substrate, including an ultimate tip, and a first cutting surface and a second cutting surface extending from the ultimate tip and corresponding to the first surface and the second surface, respectively, wherein the first cutting surface includes a first facet extending from the ultimate tip and a second facet extending from the first facet, the second cutting surface includes a third facet extending from the ultimate tip and corresponding to the first facet and the second facet, a first line tangent to the first facet and a second line tangent to the second facet are not parallel, and the ultimate tip is deviated from a central line that divides the substrate in two and passes through the substrate tip.

### TECHNICAL FIELD

The present disclosure relates to an asymmetric razor blade.

### BACKGROUND ART

The description of this part only provides the background information of the present disclosure without configuring the related art.

A feeling of shaving experienced by a user can greatly depending on the shape of razor blades. In particular, the shape of a substrate of a razor blade significantly impact a cutting force of the razor blade.

In general, as the thickness of a substrate becomes thinner, the cutting force of a razor blade decreases, and in this case, a user may have a more comfortable shaving feel. However, when the thickness of a substrate decreases to a predetermined value or smaller, a durability of a razor blade may be deteriorated. That is, in the design of a razor blade profile, there is a trade-off relationship between the comfortable shaving feel and the durability of the razor blade.

In relation to this, it has been known that a region close to the tip of a razor blade has a high correlation with the durability of the razor blade and a region far from the tip of the razor blade has the high correlation with the cutting force of the razor blade.

U.S. Pat. No. 10,549,438 (hereafter, Patent Document 1) discloses a razor blade in the related art that has a profile of a razor blade having two facets in consideration of these correlations.

Specifically, the razor blade of Patent Document 1 includes a pair of first facets extending from the tip of the razor blade and a pair of second facets extending from the first facets, respectively. Further, the first facets and the second facets are wedge-shaped, and the pair of first facets are configured to form a wide facet angle.

Through this, the razor blade of Patent Document 1 may have a relatively wide area in the region close to the tip, and a relatively narrow area in the region far from the tip. Accordingly, the razor blade of Patent Document 1 can provide a comfortable shaving feel while also having high durability.

Meanwhile, during shaving, a razor blade is moved in a shaving direction in a slightly tilted state with respect to a skin surface. In this case, a cutting edge of the razor blade may be divided into a non-facing edge disposed at the front in the shaving direction and a facing edge disposed at the rear in the shaving direction. At least a portion of the facing edge among these edges directly faces the skin of a user during shaving.

A contact between a razor blade and the user's skin may directly affect the shaving feel and the durability of the razor blade. In this respect, a facing edge that is adjacent to the skin of a user may have more impact on a shaving feel and durability in comparison to a non-facing edge.

Accordingly, when designing the profile of a razor blade, it is necessary to design a non-facing edge and a facing edge differently to reflect the characteristics of each edge.

However, conventional razor blades of the related art including Patent Document 1 generally have a cutting edge having a symmetric shape without differentiating between a non-facing edge and a facing edge. That is, the characteristics of the non-facing edge and the facing edge are not sufficiently considered in most razor blades of the related art.

### DISCLOSURE

### Technical Problem

Accordingly, a main purpose of the present disclosure is to provide a shape of an asymmetric razor blade that can improve the durability of the razor blade and reduce the cutting force of the razor blade.

### Technical Solution

According to an embodiment of the present disclosure, a razor blade is provided, the razor blade including a substrate including a substrate tip, and a first surface and a second surface extending from the substrate tip; and a coating, stacked on the substrate, including an ultimate tip, and a first cutting surface and a second cutting surface extending from the ultimate tip and corresponding to the first surface and the second surface, respectively, wherein the first cutting surface includes a first facet extending from the ultimate tip and a second facet extending from the first facet, the second cutting surface includes a third facet extending from the ultimate tip and corresponding to the first facet and the second facet, a first line tangent to the first facet and a second line tangent to the second facet are not parallel, and the ultimate tip is deviated from a central line that divides the substrate in two and passes through the substrate tip.

### Advantageous Effects

According to the present embodiment as described above, asymmetric cutting edges having shapes different from each other are provided, so there is an effect in that it is possible to improve durability and reduce cutting force.

### BRIEF DESCRIPTION OF DRAWINGS

FIGS. 1 to 3 are schematic views of a region close to an ultimate tip of a razor blade according to an embodiment of the present disclosure.

FIG. 4 shows an enlarged view of an intersection of some lines of the lines shown in FIG. 3.

FIG. 5 is a schematic view of a razor blade according to an embodiment of the present disclosure.

FIG. 6 is an exemplary view showing a situation in which razor is performed using a razor including the razor blade according to an embodiment of the present disclosure.

FIG. 7 shows an example in which the razor blade according to an embodiment of the present disclosure is applied to a double edge blade.

FIG. 8 is a schematic view of a razor blade according to a modified embodiment of the present disclosure.

FIG. 9 is a schematic view of a region close to an ultimate tip of a razor blade according to another embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

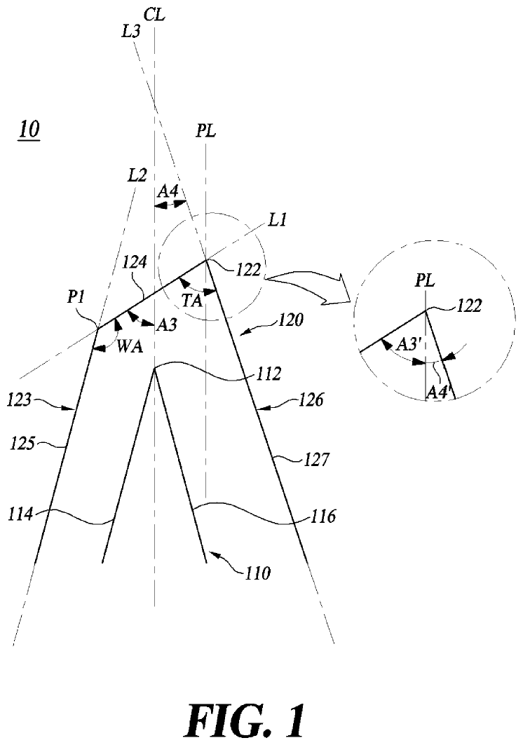

FIGS. 1 to 3 are schematic views of a region close to an ultimate tip 122 of a razor blade 10 according to an embodiment of the present disclosure.

Referring to FIG. 1, the razor blade 10 may include a substrate 110 and a coating 120 deposited on the substrate 11.

The substrate 110 may include a substrate tip 112, a first surface 114, and a second surface 116.

The first surface 114 and the second surface 116 may extend from the substrate tip 112 and may be divided in two, so that it may be substantially symmetric with respect to a central line CL passing through the substrate tip 112.

In this case, in order to implement a shape of asymmetric cutting surfaces 123 and 126, the coating formed on the first surface 114 and the coating 120 formed on the second surface 116 may have different thicknesses or shapes from each other.

However, the present disclosure is not limited thereto, and the first surface 114 and the second surface 116 may be asymmetric. In this case, the shape of the first surface 114 may correspond to the shape of a first cutting surface 123 and the shape of the second surface 116 may correspond to the shape of a second cutting surface 126.

The substrate 110 may include at least one of stainless steel, carbon steel, or ceramic. However, the present disclosure is not limited thereto, and the substrate 110 may include other materials.

The coating 120 may include an ultimate tip 122, a first cutting surface 123, and a second cutting surface 126.

The first cutting surface 123 and the second cutting surface 126 may extend from the ultimate tip 122.

The first cutting surface 123 may correspond to the first surface 114 of the substrate 110 and may be disposed to be adjacent to the first surface 114. The second cutting surface 126 may correspond to the second surface 116 of the substrate 110 and may be disposed to be adjacent to the second surface 116.

The first cutting surface 123 may include a first facet 124 extending from the ultimate tip 122 and a second facet 125 extending from the first facet 124.

A first line L1 that is tangent to the first facet 124 and a second line L2 that is tangent to the second facet 125 may not be parallel to each other. That is, the first cutting surface 123 may have a wedge shape at the connection point of the first facet 124 and the second facet 125.

In this case, a wedge angle WA that is the angle between the first line L1 and the second line L2 may be between 100 degrees to 160 degrees, and preferably, may be between 110 degrees to 140 degrees. However, the numerical ranges described above are only examples and the present disclosure is not limited thereto.

Since the first cutting surface 123 has a wedge shape, the thickness of the razor blade 10 at a region close to the ultimate tip 122 may be relatively thick and the thickness of the razor blade 10 at the region far from the ultimate tip 122 may be relatively thin.

The region of the razor blade 10 close to the ultimate tip 122 may have a high correlation with the durability of the razor blade 10 and the region of the razor blade 10 far from the ultimate tip 122 may have a high correlation with the cutting force of the razor blade 10.

Accordingly, through the wedge shape of the first cutting surface 123, the razor blade 10 according to an embodiment of the present disclosure can improve durability while reducing a cutting force.

The second cutting surface 126 may include a third facet 127 extending from the ultimate tip 122.

The third facet 127 may correspond to the first facet 124 and the second facet 125. That is, the third facet 127 may face the first facet 124 and the second facet 125.

Unlike the first cutting surface 123 having a wedge shape, the third facet 127 of the second cutting surface 126 may have a substantially flat profile. Accordingly, the first cutting surface 123 and the second cutting surface 126 may have asymmetric shapes.

Meanwhile, one of the first cutting surface 123 and the second cutting surface 126 may be a non-facing edge and the other one of the first cutting surface 123 and the second cutting surface 126 may be a facing edge. Accordingly, the razor blade 10 according to an embodiment of the present disclosure may have a shape in which a non-facing edge and a facing edge are asymmetric to each other.

The ultimate tip 122 may be deviated from the central line CL that divides the substrate 110 in two and passes through the substrate tip 112.

For example, the ultimate tip 122 may be biased toward the second surface 116 with respect to the central line CL. In this case, the thickness of the coating 120 forming the second cutting surface 126 may be relatively thick, and accordingly, the durability of the second cutting surface 126 can be improved.

However, the present disclosure is not limited thereto. For example, the ultimate tip 122 may be positioned on the central line CL or may be biased toward the first surface 114 from the central line CL.

When the ultimate tip 122 is biased toward the first surface 114 with respect to the central line CL, the thickness of the coating 120 forming the first cutting surface 123 may be relatively thick, and accordingly, the durability of the first cutting surface 123 can be improved.

A tip angle TA that is the angle between the first line L1 and the third line L3 that is tangent to the third facet 127 may be 55 degrees to 130 degrees, preferably 55 degrees to 100 degrees, and more preferably 60 degrees to 90 degrees. However, the numerical ranges described above are only examples and the present disclosure is not limited thereto.

Meanwhile, the tip angle TA defined in the region close to the ultimate tip 122 of the razor blade 10 has a high correlation with the durability of the razor blade 10. For example, the larger the tip angle TA, the more the durability of the razor blade 10 may be improved.

Accordingly, because the razor blade 10 according to an embodiment of the present disclosure has a large tip angle TA, the durability of the razor blade 10 can be further improved.

A third angle A3 between the first line L1 and the central line CL may be different from a fourth angle A4 between the third line L3 and the central line CL. For example, the third angle A3 may be larger than the fourth angle A4.

Meanwhile, in the enlarged view of FIG. 1, an angle A3′ between a perpendicular line PL and the first line L1, and an angle A4′ between the perpendicular line PL and the third line L3 are shown. In this case, the perpendicular line PL is defined as a line passing through the ultimate tip 122 and parallel with the central line CL.

Since the perpendicular line PL and the central line CL are parallel, the third angle A3 between the first line L1 and the central line CL may have the same value as the angle A3′ between the first line L1 and the perpendicular line PL, and the fourth angle A4 between the third line L3 and the central line CL may have the same value as the angle A4′ between the third line L3 and the perpendicular line PL.

Accordingly, similar to the third angle A3 and the fourth angle A4, the angle A3′ between the perpendicular line PL and the first line L1 may be different from the angle A4′ between the perpendicular line PL and the third line L3. For example, the angle A3′ between the perpendicular line PL and the first line L1 may be larger than the angle A4′ between the perpendicular line PL and the third line L3.

When the angle A3′ between the perpendicular line PL and the first line L1 is different from the angle A4′ between the perpendicular line PL and the third line L3, the first cutting surface 123 and the second cutting surface 126 have shapes asymmetric to each other with reference to the perpendicular line PL.

In other words, when the third angle A3 and the fourth angle A4 are different, the first cutting surface 123 and the second cutting surface 126 may have shapes asymmetric to each other with reference to the perpendicular line PL. In FIG. 1, the third angle A3 is shown as being larger than the fourth angle A4, but the present disclosure is not limited thereto. For example, the third angle A3 may be smaller than the fourth angle A4, or the third angle A3 and the fourth angle A4 may be the same as each other. Even in this case, the first cutting surface 123 and the second cutting surface 126 may have shapes asymmetric to each other with reference to the perpendicular line PL.

The coating 120, in order to reinforce the durability of the razor blade 10, may include a hard coating layer. For example, the hard coating layer of the coating 120 may include at least one of diamond like carbon (DLC), Cr, Pt, CrB, or CrC. However, the present disclosure is not limited thereto and the hard coating layer of the coating 120 may include other materials.

The coating 120, in order to reduce friction force of the razor blade 10, may include a soft coating layer. For example, the soft coating layer of the coating 120 may include Polytetrafluoroethylene (PTFE). However, the present disclosure is not limited thereto and the soft coating layer of the coating 120 may include other materials in addition to PTFE.

The coating layer 120 may further include an overcoat layer disposed between the hard coating layer and the soft coating layer, and an adhesive layer disposed between the substrate 110 and the hard coating layer.

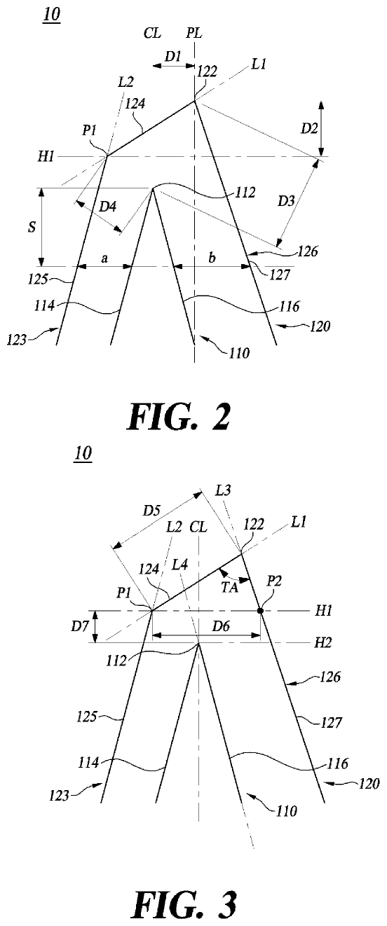

Referring to FIG. 2, at a point a predetermined distance away from the substrate tip 112, a first thickness a between the first surface 114 and the first cutting surface 123 may have a value relatively smaller than a second thickness b between the second surface 116 and the second cutting surface 126.

Specifically, the value obtained by dividing the first thickness a by the second thickness b may be 0.1 to 2.5, preferably 0.2 to 2.0, and more preferably 0.25 to 1.0. However, the numerical ranges described above are only examples and the present disclosure is not limited thereto.

By making the second thickness b thicker than the first thickness a, the thickness of the coating 120 forming the second cutting surface 126 may be relatively increased. Accordingly, the durability of the second cutting surface 126 can be improved.

A first distance D1 between the perpendicular line PL and the central line CL may be within the rage of 20 nanometers to 300 nanometers, preferably 30 nanometers to 250 nanometers, and more preferably 35 nanometers to 170 nanometers. However, the numerical ranges described above are only examples and the present disclosure is not limited thereto.

As the value of the first distance D1 increases, the thickness of the coating 120 forming the second cutting surface 126 may be relatively increased.

A second distance D2 between a first horizontal line H1 and the ultimate tip 122 may be 50 nanometers to 400 nanometers, preferably 50 nanometers to 300 nanometers, and more preferably 50 nanometers to 200 nanometers. However, the numerical ranges described above are only examples and the present disclosure is not limited thereto.

In this case, the first horizontal line H1 is defined as a line passing through a first point P1 and perpendicular to the central line CL, and the first point P1 is defined as a point at which the first line L1 and the second line L2 intersect.

A third distance D3 between the substrate tip 112 and the ultimate tip 122 may be 100 nanometers to 600 nanometers, preferably 100 nanometers to 400 nanometers, and more preferably 100 nanometers to 300 nanometers. However, the numerical ranges described above are only examples and the present disclosure is not limited thereto.

A fourth distance D4 between the first point P1 and the substrate tip 112 may be 100 nanometers to 400, and preferably 100 nanometers to 250 nanometers. However, the numerical ranges described above are only examples and the present disclosure is not limited thereto.

Referring to FIG. 3, a fifth distance D5 between the first point P1 and the ultimate tip 122 may be 100 nanometers to 600 nanometers, preferably 100 nanometers to 400 nanometers, and more preferably 100 nanometers to 250 nanometers. However, the numerical ranges described above are only examples and the present disclosure is not limited thereto.

A sixth distance D6 between the first point P1 and the second point P2 may be 150 nanometers to 700 nanometers, preferably 150 nanometers to 400 nanometers, and more preferably 150 nanometers to 300 nanometers. However, the numerical ranges described above are only examples and the present disclosure is not limited thereto. In this case, the second point P2 is defined as a point at which the first horizontal line H1 and the third facet 127 intersect.

A seventh distance D7 between the first horizontal line H1 and a second horizontal line H2 may be 20 nanometers to 350 nanometers, preferably 20 nanometers to 250 nanometers, and more preferably 20 nanometers to 150 nanometers. However, the numerical ranges described above are only examples and the present disclosure is not limited thereto. In this case, the second horizontal line H2 is defined as a line passing through the substrate tip 112 and parallel with the first horizontal line H1.

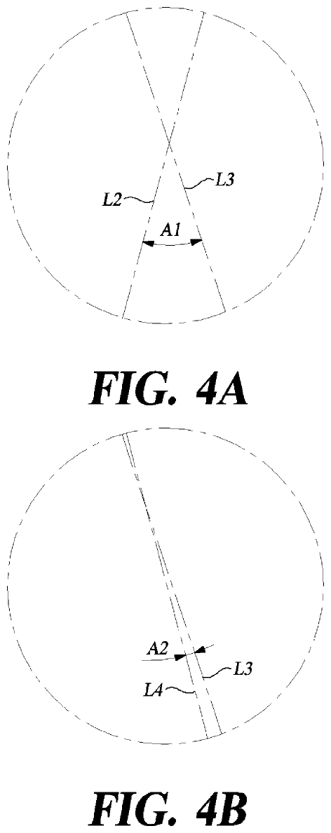

FIG. 4 shows an enlarged view of an intersection of some lines of the lines shown in FIG. 3.

Specifically, FIG. 4A shows an intersection of the second line L2 and the third line L3 and FIG. 4B shows an intersection of the third line L3 and the fourth line L4.

Referring to FIGS. 3 and 4, a value obtained by dividing the tip angle TA by the first angle A1 between the second line L2 and the third line L3 may be 1.5 to 3.5. However, the numerical range described above is only an example and the present disclosure is not limited thereto.

A second angle A2 that is the angle between the third line L3 and a fourth line L4 that is tangent to the second surface 116 may be 10 degrees to 40 degrees, and preferably 15 degrees to 30 degrees. However, the numerical ranges described above are only examples and the present disclosure is not limited thereto.

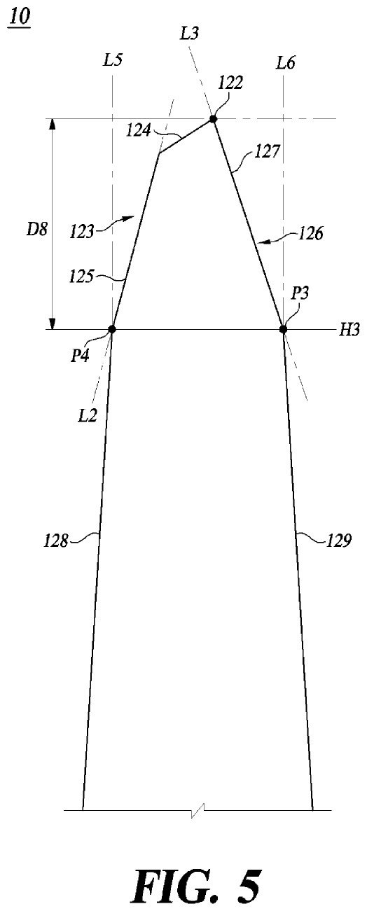

FIG. 5 is a schematic view of the razor blade 10 according to an embodiment of the present disclosure.

Referring to FIG. 5, the first cutting surface 123 may include a fourth facet 128 extending from the second facet 125, and the second cutting surface 126 may include a fifth facet 129 extending from the third facet 127.

The fourth facet 128 and the fifth facet 129 may have shapes symmetric to each other.

Meanwhile, an eighth distance D8 between a third horizontal line H3 and the ultimate tip 122 may be 10 micrometers or less, and preferably 5 micrometers or less. However, the numerical ranges described above are only examples and the present disclosure is not limited thereto.

In this case, the third horizontal line H3 is defined as a line passing through the third point P3 and perpendicular to the central line CL, and the third point P3 is defined as an intersection at which the third line L3 and a sixth line L6 that is tangent to the fifth facet 129 intersect.

Because the fourth facet 128 and the fifth facet 129 have shapes symmetric to each other, with respect to the third point P3, the region of the second cutting surface 126 before the third point P3 may be asymmetric to the first cutting surface 123 corresponding thereto, and, in contrast, the region of the second cutting surface 126 after the third point P3 may be symmetric to the region of the first cutting surface 123 corresponding thereto.

In other words, in a region within the eighth distance D8 from the ultimate tip 122, the first cutting surface 123 and the second cutting surface 126 may be asymmetric, and in the region beyond the eighth distance D8 from the ultimate tip 122, the first cutting surface 123 and the second cutting surface 126 may be symmetric.

Accordingly, by configuring the region within the eighth distance D8 from the ultimate tip 122 to be asymmetric, the razor blade 10 according to an embodiment of the present disclosure can have an effect that it is differentiated from razor blades of the related art.

Meanwhile, in FIG. 5, the fourth point P4 defined as the point at which the fifth line L5 that is a tangent to the fourth facet 128 and the second line L2 intersect is shown as being positioned on the third horizontal line H3, but the present disclosure is not limited thereto.

For example, the fourth point P4 may be positioned in the region within the eighth distance D8 from the ultimate tip 122 or may be positioned in the region beyond the eighth distance D8 from the ultimate tip 122.

Further, in FIG. 5, the second facet 125 and the fourth facet 128 are shown as forming a wedge shape and the third facet 127 and the fifth facet 129 are shown as forming a wedge shape, but the present disclosure is not limited thereto.

For example, the second and fourth facets 125 and 128 and the third and fifth facets 127 and 129 each may be smoothly connected without forming a wedge shape. In this case, the second and fourth facets 125 and 128 and the third and fifth facets 127 and 129 each may form a flat profile.

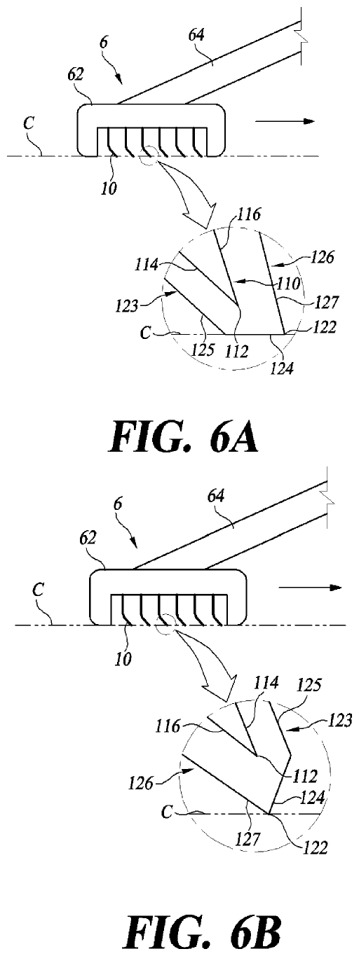

FIG. 6 is an exemplary view showing a situation in which shaving is performed using a razor 6 including the razor blade 10 according to an embodiment of the present disclosure.

In detail, FIG. 6A shows the razor blade 10 in which the first cutting surface 123 is a facing edge, and FIG. 6B shows the razor blade 10 in which the second cutting surface 126 is a facing edge.

Referring to FIG. 6A and FIG. 6B, a razor 6 may include a razor cartridge 62 and a razor handle 64 extending from the razor cartridge 62.

The razor cartridge 62 may be connected with the razor handle 64 or may be formed integrally with the razor handle 64.

The razor cartridge 62 may accommodate at least one razor blade 10 therein.

The razor blade 10 may be a bent blade or a welded blade, but the present disclosure is not limited thereto. For example, the razor blade 10 may be a straight blade.

Referring to FIG. 6A, at least a portion of the first cutting surface 123 which is a facing edge may be adjacent to the skin C of a user during shaving.

Further, the first cutting surface 123 may have a wedge shape between the first facet 124 and the second facet 125, and this wedge shape may form a region protruding on the first cutting surface 123.

Accordingly, when the razor blade 10 is positioned close to the skin C such that it comes in contact with the skin C, the first cutting surface 123 can come in contact with the skin C over a larger region.

In this case, the tendency of the ultimate tip 122 coming in contact with the skin C can be decrease, so the razor blade 10 can provide a comfortable shaving feel without scratching, cutting, scraping, etc.

Referring to FIG. 6B, at least a portion of the second cutting surface 126 which is a facing edge may be adjacent to the skin C of a user during shaving.

Further, the third facet 127 of the second cutting surface 126 may have a flat profile. Accordingly, when the razor blade 10 is positioned close to the skin C such that it comes in contact with the skin C, the second surface 126 can come in contact with the skin C over a smaller region.

In this case, the ultimate tip 122 may be closer to a lower region of hairs adjacent to the skin C, and accordingly, hairs cut by the razor blade 10 may have a shorter length. Accordingly, the razor blade 10 can provide more clean shaving.

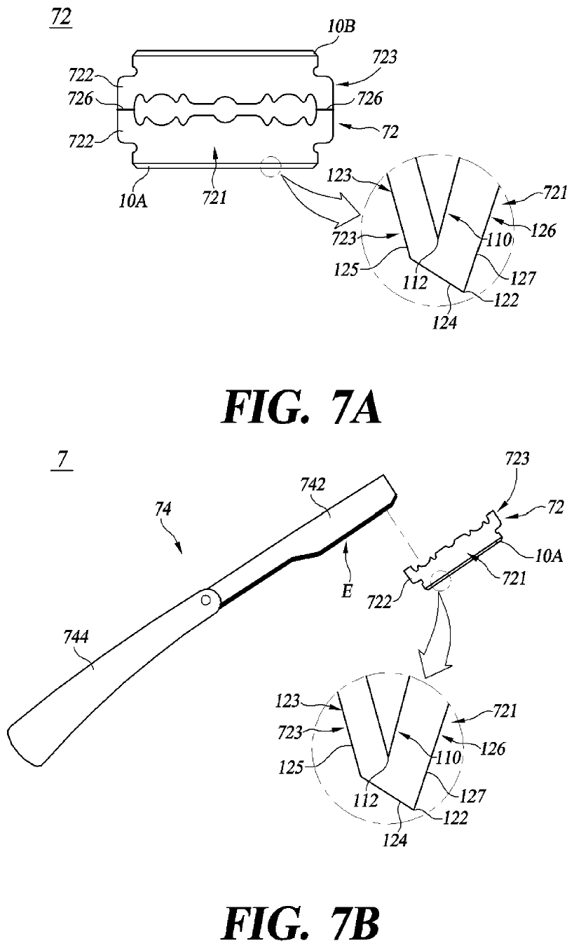

FIG. 7 shows an example in which the razor blade 10 according to an embodiment of the present disclosure is applied to a double edge blade 72.

In detail, FIG. 7A shows a double edge blade 72 and FIG. 7B shows a razor device 7 including the double edge blade 72.

Referring to FIG. 7A, the double edge blade 72 may include a blade body 722 and first and second razor blades 10A and 10B formed on the blade body 722.

At least one of the first razor blade 10A or the second razor blade 10B is the razor blade 10 according to an embodiment of the present disclosure and may have asymmetric cutting surfaces 123 and 126. For example, with respect to the first razor blade 10A, the second cutting surface 126 may be formed on one side 721 of the double edge blade 72 and the first cutting surface 123 may be formed on another side 723 of the double edge blade 72.

The first razor blade 10A and the second razor blade 10B both may include the asymmetric cutting surfaces 123 and 126 according to an embodiment of the present disclosure, but the present disclosure is not limited thereto. Accordingly, one of the first razor blade 10A and the second razor blade 10B may have asymmetric cutting surfaces and the other one may have symmetric cutting surfaces.

Meanwhile, when both of the first razor blade 10A and the second razor blade 10B include the asymmetric cutting surfaces 123 and 126, the first razor blade 10A and the second razor blade 10B may have the same kind of cutting surfaces on the same surface of the double edge blade 72.

For example, the first razor blade 10A and the second razor blade 10B may have the second cutting surface 126 on one side 721 of the double edge blade 72 and may have the first cutting surface 123 on another side 723 of the double edge blade 72.

However, the present disclosure is not limited thereto, and the first razor blade 10A and the second razor blade 10B may have different kinds of cutting surfaces on the same surface of the double edge blade 72.

The double edge blade 72 may be separated into a plurality of segments through a cutting line 726. For example, the double edge blade 72 may be separated into two segments such that each of the segments has one razor blade 10A, 10B. However, the present disclosure is not limited thereto and the double edge blade 72 may be separated into three or more segments or may not be separated.

One of a plurality of segments of the double edge blade 72 may be mounted on a blade holder 74 and used. However, the present disclosure is not limited thereto. For example, the double edge blade 72 may be configured to be mounted on the blade holder 74 intactly without being divided.

In FIG. 7A, the double edge blade 72 is shown as having two razor blades 10A and 10B, but the present disclosure is not limited thereto. For example, the double edge blade 72 may include only one razor blade 10 having asymmetric cutting surfaces 123 and 126.

Referring to FIG. 7B, the razor device 7 may include the double edge blade 72 and the blade holder 74.

The blade holder 74 may include a mounting portion 742 in which the double edge blade 72 can be mounted, and a grip portion 744 providing a grip region to a user.

The mounting portion 742 may accommodate at least a portion of the double edge blade 72 through an opening E. The razor blade 10A region of the double edge blade 72 may be exposed to the outside through the opening E.

In FIG. 7B, the mounting portion 742 is shown as having one opening E, and the segments of the double edge blade 72 are shown as being accommodated in the opening E, but the present disclosure is not limited thereto.

For example, the mounting portion 742 may include two openings E or the double edge blade 72 may be mounted in the mounting portion 742 without being divided. When the double edge blade 72 not separated is mounted on the mounting portion 742 having two openings E, the two razor blades 10A and 10B may each be exposed to the outside through the openings E, respectively.

The double edge blade 72 may be mounted in the mounting portion 742 to be replaceable. In this case, the double edge blade 72 may be mounted in the mounting portion 742 such that the directions of one side 721 and another side 723 of the double edge blade 72 are opposite.

For example, when the double edge blade 72 is mounted in the mounting portion 742 in the direction shown in FIG. 7B, the first cutting surface 123 of the first razor blade 10A may be a facing edge, and when the double edge blade 72 is mounted in the direction opposite to the direction shown in FIG. 7B, the second cutting surface 126 of the first razor blade 10A may be a facing edge.

In accordance with which surface among the first cutting surface 123 and the second cutting surface 126 is a facing edge, the razor blades 10 may have characteristics different from each other. Accordingly, a user can mount the double edge blade 72 and the segments of the double edge blade 72 into the mounting portion 742 while changing the directions of the one side 721 and the other side 723 of the double edge blade 72 in accordance with preference, and then can perform shaving.

In FIG. 7B, the double edge blade 72 is shown as being mounted on the blade holder 74 and used, but the present disclosure is not limited thereto. For example, the double edge blade 72 may be independently used without other tools such as the blade holder 74.

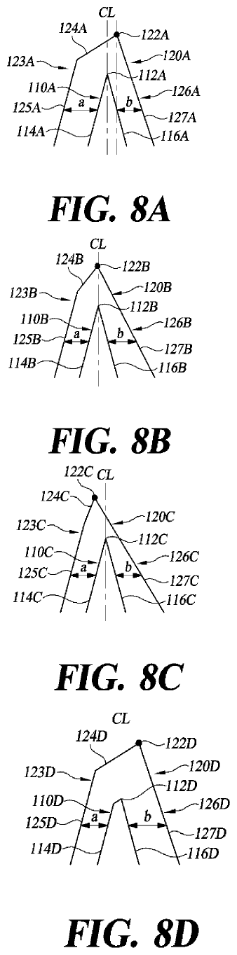

FIG. 8 is a schematic view of a razor blade according to a modified embodiment of the present disclosure.

Referring to FIG. 8A, the first thickness a between the first surface 114A and the first cutting surface 123A may have a relatively larger value than the second thickness b between the second surface 116A and the second cutting surface 126A.

By making the first thickness a larger than the second thickness b, the thickness of the coating 120 forming the first cutting surface 123 may be relatively increased, and accordingly, the durability of the first cutting surface 123 can be improved.

Referring to FIG. 8B, an ultimate tip 122B may be positioned on the central line CL. In this case, the ultimate tip 122B and a substrate tip 112B may be arranged on the same line.

In shaving, pressure by a razor blade is transmitted to the ultimate tip 122b through the substrate tip 122B, and finally, is transmitted to the skin of a user through the ultimate tip 122B. When the substrate tip 112B and the ultimate tip 122B are positioned on the central line CL, the entire pressure transmitted from the substrate tip 112B to the ultimate tip 122B, without being lost as moment, can be used to cut hairs, so that shaving may be performed with less force.

When the ultimate tip 122B is positioned on the central line CL, the first thickness a between the first cutting surface 123B and the first surface 114B may have a substantially constant value, and the second thickness b between the second cutting surface 126B and the second surface 116B may decrease toward the substrate tip 122B. Accordingly, the durability of the first cutting surface 123B may increase relatively toward the substrate tip 122B in comparison to the durability of the second cutting surface 126B. However, the present disclosure is not limited thereto, and the first thickness a and the second thickness b may be set differently in accordance with the design of the razor blade.

For example, with the ultimate tip 122B positioned on the central line CL, at least one of the first thickness a and the second thickness b may gradually decrease or gradually increase toward the substrate tip 122B, or the first thickness a and the second thickness b both may have substantially constant values.

Further, in FIG. 8B, the second thickness b is shown as having a relatively large value in comparison to the first thickness a, but the present disclosure is not limited thereto. For example, the first thickness a may have a relatively large value in comparison to the second thickness b, or the first thickness a and the second thickness b may have substantially similar values.

Referring to FIG. 8C, an ultimate tip 122C may be biased toward a first surface 114C from the central line CL.

When the ultimate tip 122C is biased toward the first surface 114C with respect to the central line CL, the first thickness a between the first cutting surface 123C and the first surface 114C may have a substantially constant value, and the second thickness b between the second cutting surface 126C and the second surface 116C may decrease toward the substrate tip 122C. Accordingly, the durability of the first cutting surface 123C may relatively increase toward the substrate tip 122C in comparison to the durability of the second cutting surface 126C.

Meanwhile, referring to FIG. 8B and FIG. 8C, when the ultimate tip 122C is biased toward the first surface 114C from the central line CL, the tendency of the second thickness b to decrease toward the substrate tip 122B may increase in comparison to the case in which the ultimate tip 122B is positioned on the central line CL.

Referring to FIG. 8D, the first surface 114D and the second surface 116D of the substrate 110D may be asymmetric with respect to the central line CL.

In this case, the shape of the first surface 114D may correspond to the first cutting surface 123D and the shape of the second surface 116D may correspond to the second cutting surface 126D.

Further, by making the second thickness b thicker than the first thickness a, the thickness of the coating 120D forming the second cutting surface 126D may be relatively increased, and accordingly, the durability of the second cutting surface 126D can be improved.

The embodiments shown in FIG. 8A to FIG. 8D is at most a portion of several embodiments of the present disclosure. Accordingly, the razor blade 10 according to an embodiment of the present disclosure may have other shapes and structures in addition to the embodiments shown in FIG. 8A to FIG. 8D.

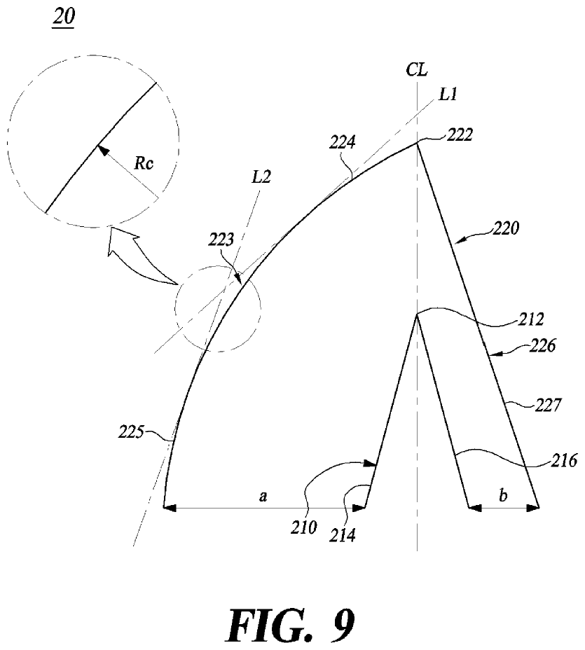

Another embodiment of the present disclosure shown in FIG. 9 to be described below has a difference, from the embodiments of the present disclosure shown in FIGS. 1 to 8, in that at least a portion of the first cutting surface has a convex profile. Hereinafter, different features according to another embodiment of the present disclosure are mainly described and repeated description of the configuration substantially the same as an embodiment of the present disclosure is omitted.

FIG. 9 is a schematic view of a region close to an ultimate tip 222 of a razor blade 20 according to another embodiment of the present disclosure.

Referring to FIG. 9, the razor blade 20 according to another embodiment of the present disclosure may include a substrate 210 and a coating 220 deposited on the substrate 210.

The substrate 210 may include a substrate tip 212, a first surface 214, and a second surface 216.

The first surface 214 and the second surface 216 may extend from the substrate tip 212 and may be substantially symmetric with respect to a central line CL dividing the substrate 210 in two and passing through the substrate tip 212.

In this case, in order to implement a shape of asymmetric cutting surfaces 223 and 226, the coating formed on the first surface 214 and the coating 220 formed on the second surface 216 may have thicknesses or shapes different from each other.

However, the present disclosure is not limited thereto, and the first surface 214 and the second surface 216 may be asymmetric. In this case, the shape of the first surface 214 may correspond to the shape of a first cutting surface 223 and the shape of the second surface 216 may correspond to the shape of the second cutting surface 226.

The substrate 210 may include at least one of stainless steel, carbon steel, and ceramic. However, the present disclosure is not limited thereto and the substrate 210 may include other materials.

The coating 220 may include an ultimate tip 222, a first cutting surface 223, and a second cutting surface 226.

The first cutting surface 223 and the second cutting surface 226 may extend from the ultimate tip 222.

The first cutting surface 223 may correspond to the first surface 214 of the substrate 210 and may be disposed to be adjacent to the first surface 214. The second cutting surface 226 may correspond to the second surface 216 of the substrate 210 and may be disposed to be adjacent to the second surface 216.

The first cutting surface 223 may include a first facet 224 extending from the ultimate tip 222 and a second facet 225 extending from the first facet 224. A first line L1 that is tangent to the first facet 224 and a second line L2 that is tangent to the second facet 225 may not be parallel to each other.

At least a portion of the first cutting surface may have a convex profile. Accordingly, a convex region of the first cutting surface 223 may be formed throughout the entire first cutting surface 223 but may also be formed in only a partial region of the first cutting surface 223.

When the convex region of the first cutting surface 223 is formed in only a partial region of the first cutting surface 223, the convex region of the first cutting surface 223 may be formed at any one of the first facet 224 and the second facet 225 or may be formed at both of the first facet 224 and the second facet 225.

Further, the convex region of the first cutting surface 223 may be formed in the entire region of at least one of the first facet 224 or the second facet 225, but may be formed in only a partial region of at least one of the first facet 224 and the second facet 225.

For example, when the convex region of the first cutting surface 223 is formed at the first facet 224, the convex region of the first cutting surface 223 may be formed from the ultimate tip 222 to a middle region of the first facet 224 or may be formed from the middle region of the first facet 224 to the boundary of the first facet 224 and the second facet 225.

When the first cutting surface 223 having a convex profile is a facing edge and when the razor blade 20 is close to skin C such that it comes in contact with the skin C, the first cutting surface 223 can come in contact with the skin C more smoothly, and accordingly, skin irritation by the razor blade 20 can be minimized. Accordingly, the razor blade 20 according to another embodiment of the present disclosure has an effect that it can provide a comfortable shaving feel to a user.

Meanwhile, a radius of curvature Rc of at least a portion of the first cutting surface 223, for example, the first cutting surface 223 in a region of the razor blade 20 0.0 micrometers to 0.5 micrometers away from ultimate tip 222, may be 0.5 micrometers to 1.5 micrometers, and preferably 0.7 micrometers to 1.2 micrometers. Accordingly, the razor blade 20 according to another embodiment of the present disclosure can have an excellent cutting force while providing a comfortable shaving feel to a user.

The second cutting surface 226 may include a third facet 227 extending from the ultimate tip 222.

The third facet 227 may correspond to the first facet 224 and the second facet 225. That is, the third facet 227 may face the first facet 224 and the second facet 225.

Unlike the first cutting surface 223 having a convex profile, the third facet 227 of the second cutting surface 226 may have a substantially flat profile. Accordingly, the first cutting surface 223 and the second cutting surface 226 may have asymmetric shapes.

The ultimate tip 222 may be positioned on the central line CL. In this case, the ultimate tip 222 and the substrate tip 212 may be disposed on the same line. When the substrate tip 212 and the ultimate tip 222 are positioned on the central line CL, the entire pressure transmitted from the substrate tip 212 to the ultimate tip 222 without being lost as moment can be used to cut hairs, so that shaving may be performed with a less force.

However, the present disclosure is not limited thereto and ultimate tip 222 may be deviated from the central line CL. For example, the ultimate tip 222 may be biased toward the second surface 216 from the central line CL. In this case, the thickness of the coating 220 forming the second cutting surface 226 may be relatively thick, and accordingly, the durability of the second cutting surface 226 can be improved.

On the contrary, the ultimate tip 222 may be biased toward the first surface 214 from the central line CL. When the ultimate tip 222 is biased toward the first surface 214 from the central line CL, the thickness of the coating 220 forming the first cutting surface 223 may be relatively thick, and accordingly, the durability of the first cutting surface 223 can be improved.

Meanwhile, at a point a predetermined distance away from the substrate tip 212, a first thickness a between the first surface 214 and the first cutting surface 223 may have a value relatively larger than a second thickness b between the second surface 216 and the second cutting surface 226.

By making the first thickness a larger than the second thickness b, the thickness of the coating 220 forming the first cutting surface 223 may be relatively increased. Accordingly, the durability of the first cutting surface 223 can be improved.

However, the present disclosure is not limited thereto. For example, the second thickness b may have a relatively large value in comparison to the first thickness a, or the first thickness a and the second thickness b may have substantially similar values.

When the ultimate tip 222 is positioned on the central line CL, the first thickness a may decrease toward the substrate tip 222 and the second thickness b may have a substantially constant value. However, the present disclosure is not limited thereto, and the first thickness a and the second thickness b may be set differently in accordance with the design matters of the razor blade.

For example, with the ultimate tip 222 positioned on the central line CL, at least one of the first thickness a or the second thickness b may gradually decrease or gradually increase toward the substrate tip 222, or the first thickness a and the second thickness b both may have substantially constant values.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

[REFERENCE NUMERIALS] 10: razor blade, 110: substrate, 112: substrate tip, 114: first surface, 116: second surface, 120: coating, 122: ultimate tip, 123: first cutting surface, 124: first facet, 125: second facet, 126: second cutting surface, 127: third facet, 128: fourth facet, 129: fifth facet, CL: central line, PL: perpendicular line, TA: tip angle, WA: wedge angle, A1: first angle, A2: second angle, A3: third angle, A4: fourth angle, H1 to H3: first to third horizontal lines, L1 to L6: first to sixth lines, P1 to P3: first to third points, D1 to D8: first to eighth distances.

### CROSS-REFERENCE TO RELATED APPLICATION

This application claims priority to Patent Application No. 10-2020-0140236, filed on Oct. 27, 2020 in Korea, and Patent Application No. 10-2021-0093298, filed on Jul. 16, 2021 in Korea, the entire contents of which are incorporated herein by reference.

1. A razor blade comprising:
a substrate including a substrate tip, and a first surface and a second surface extending from the substrate tip; and
a coating, layered on the substrate, including an ultimate tip, and a first cutting surface and a second cutting surface extending from the ultimate tip and corresponding to the first surface and the second surface, respectively,
wherein the first cutting surface includes a first facet extending from the ultimate tip and a second facet extending from the first facet,
the second cutting surface includes a third facet extending from the ultimate tip and corresponding to the first facet and the second facet,
a first line tangent to the first facet and a second line tangent to the second facet are not parallel, and
the ultimate tip is deviated from a central line that divides the substrate in two and passes through the substrate tip.

2. The razor blade of claim 1, wherein the third facet has a flat profile.

3. The razor blade of claim 1, wherein the ultimate tip is biased toward the second surface from the central line.

4. The razor blade of claim 1, wherein a value obtained by dividing a first thickness between the first surface and the first cutting surface by a second thickness between the second surface and the second cutting surface at a point a predetermined distance away from the substrate tip is between 0.1 and 2.5.

5. The razor blade of claim 1, wherein a first distance between the central line and a perpendicular line that passes through the ultimate tip and is parallel with the central line is between 20 nanometers and 300 nanometers.

6. The razor blade of claim 1, wherein a wedge angle which is an angle between the first line and the second line is between 100 degrees and 160 degrees.

7. The razor blade of claim 1, wherein a tip angle which is an angle between the first line and a third line tangent to the third facet is between 55 degrees and 130 degrees.

8. The razor blade of claim 1, wherein a second distance between the ultimate tip and a first horizontal line that passes through a first point at which the first line and the second line intersect and is perpendicular to the central line is between 50 nanometers and 400 nanometers.

9. The razor blade of claim 1, wherein a third distance between the substrate tip and the ultimate tip is between 100 nanometers and 600 nanometers.

10. The razor blade of claim 1, wherein a fourth distance between the substrate tip and a first point at which the first line and the second line intersect is between 100 nanometers and 400 nanometers.

11. The razor blade of claim 1, wherein a fifth distance between the ultimate tip and a first point at which the first line and the second line intersect is between 100 nanometers and 600 nanometers.

12. The razor blade of claim 1, wherein a value obtained by dividing a tip angle which is an angle between the first line and a third line tangent to the third facet by a first angle between the second line and the third line is between 1.5 and 3.5.

13. The razor blade of claim 1, wherein a sixth distance between a first point at which the first line and the second line intersect, and a second point at which a first horizontal line that passes through the first point and is perpendicular to the central line intersects the third facet is between 150 nanometers and 700 nanometers.

14. The razor blade of claim 1, wherein a seventh distance between a first horizontal line that passes through a first point at which the first line and the second line intersect and is perpendicular to the central line, and a second horizontal line that passes through the substrate tip and is parallel with the first horizontal line is between 20 nanometers and 350 nanometers.

15. The razor blade of claim 1, wherein a second angle being an angle between a third line being tangent to the third facet and a fourth line being tangent to the second surface is between 10 degrees and 40 degrees.

16. The razor blade of claim 1, wherein at least a portion of the first cutting surface has a convex profile.

17. The razor blade of claim 16, wherein at least a portion of a convex region of the first cutting surface has a radius of curvature between 0.5 micrometers and 1.5 micrometers.

18. A razor blade comprising:
a substrate including a substrate tip, and a first surface and a second surface extending from the substrate tip; and
a coating, layered on the substrate, including an ultimate tip, and a first cutting surface and a second cutting surface extending from the ultimate tip and corresponding to the first surface and the second surface, respectively,
wherein the first cutting surface includes a first facet extending from the ultimate tip and a second facet extending from the first facet,
the second cutting surface includes a third facet extending from the ultimate tip and corresponding to the first facet and the second facet,
a first line tangent to the first facet and a second line tangent to the second facet are not parallel, and
the third facet has a flat profile.

19. The razor blade comprising:
a substrate including a substrate tip, and a first surface and a second surface extending from the substrate tip; and
a coating, layered on the substrate, including an ultimate tip, and a first cutting surface and a second cutting surface extending from the ultimate tip and corresponding to the first surface and the second surface, respectively,
wherein the first cutting surface includes a first facet extending from the ultimate tip and a second facet extending from the first facet,
the second cutting surface includes a third facet extending from the ultimate tip and corresponding to the first facet and the second facet,
a first line tangent to the first facet and a second line tangent to the second facet are not parallel, and
a third angle between the first line and a central line that divides the substrate in two and passes through the substrate tip is different from a fourth angle between a third line tangent to the third facet and the central line.
